(19) United States
(12) Patent Application Publication
(10) Pub. No.: US 2015/0097029 A1
(43) Pub. Date: Apr. 9, 2015

(54) Transactional Device Having Element for Identifying Wireless Sensing

(71) Applicant: Castles Technology Co., Ltd., New Taipei (TW)

(72) Inventors: Hung-Chun Lin, Hsinchu (TW); Kai-Yu Cheng, Taipei (TW)

(73) Assignee: Castles Technology Co., Ltd., New Taipei (TW)

(21) Appl. No.: 14/049,298

(22) Filed: Oct. 9, 2013

(51) Int. Cl. G06Q 20/38; G06Q 20/34

(52) U.S. Cl. CPC G06Q 20/382; G06Q 20/3567
USPC 235/380

(57) ABSTRACT

The present invention is transactional device having element for identifying wireless sensing, having an element for identifying wireless sensing having the light emission element, capable of determining whether or not the financial transaction card is at a correct position, as such, when the magnetic stripe reader of the financial transaction device reads data, the wireless data reader does not read data, such that no duplicate data reading occurs.

### BACKGROUND OF THE INVENTION

1. Field of the Invention

The invention relates to a financial transaction device having an element for identifying wireless sensing, and particularly to an ICC (Integrated Circuits Card) reader capable of financial transaction, a device having an element for identifying whether or not to perform wireless sensing and the usage method thereof.

2. Description of Related Art

A healthy economic development must come with certain inflation. Continuous inflation causes rising prices, thereby prices of commodities increase relatively. As for consumers, the increase of the unit price of a commodity indicates more cash for a successful transaction. However, it is inconvenient for consumers to carry an over large amount of money. Besides, under a robust economic system, debit and credit are important behavior to maintain economic running. Inflation cannot exist without debit and credit, and economic growth cannot exist without inflation. Therefore, financial transaction cards are developed such that it is convenient to perform financial transactions with an over large amount of cash, and the convenience of debit and credit is also improved.

The current most common transaction forms with financial transaction cards include magnetic stripe card swiping form and wireless transaction form, wherein, for the magnetic stripe card swiping form, as used, a financial transaction card is swiped through a financial transaction device with a hand for the financial transaction device to read data on stripe of the financial transaction card to perform financial transaction; while for the so called wireless transaction form, a wireless transmission chip is embedded in a financial transaction card, and as used, a financial transaction card is held with a hand to be proximate to a financial transaction device for the financial transaction device to read data of the wireless transmission chip in the financial transaction card to perform the financial transaction. Both forms have respective convenience. Composite financial transaction card developed later may be used to perform both magnetic stripe card swiping form and wireless transaction form.

As a composite financial transaction card is used for wireless transaction, in the same way, the financial transaction card is held by hand to be proximate to a financial transaction device for the financial transaction device to read data of the wireless transmission chip in the financial transaction card to perform the financial transaction. However, as the composite financial transaction car is used to perform magnetic stripe swiping, the financial transaction card is also held by hand to be proximate to the financial transaction device such that incorrect sensing is usually resulted, or sensing is duplicated to cause abnormal financial transaction.

Problems due to abnormal financial transactions are considerably complex. At first, the consumer has to indicate the incorrect financial procedure to identify that it is the financial procedure to cause duplicate sensing, followed by identifying the amount of duplicate payment to take back the duplicate payment. Because of such disadvantage, composite financial transaction cards still cannot be used popularly, thereby the convenience of financial transaction card is inhibited.

In view of this, designs of conventional financial transaction devices or financial transaction cards still have lots of shortages. To improve the shortages and increase convenience, the inventor of the application makes lots of efforts to study and try different methods with a series of tests, together with the consideration of cost, to create a financial transaction device having an element for identifying wireless sensing according to the invention.

### SUMMARY OF THE INVENTION

Therefore, it is a primary objective of the invention to provide a transactional device, having an element for identifying wireless sensing having the light emission element, capable of determining whether or not the financial transaction card is at a correct position, as such, when the magnetic stripe reader of the financial transaction device reads data, the wireless data reader does not read data, such that no duplicate data reading occurs.

To achieve the aforementioned objective, the present invention provides a financial transaction device having an element for identifying wireless sensing, and including: a housing; a transaction processor, being contained in the housing, and connected to a financial transaction center through internet; a magnetic stripe reader, being flanked and arranged on the housing, and electrically connected to the financial processor, capable of reading a first financial information from magnetic stripe, and transmitting the first financial information to the financial processor, wherein, the financial processor encrypts and transmits the first financial information to the financial transaction center; a wireless data reader, being arranged on the housing, and electrically connected to the financial processor, after being initiated by the financial processor, capable of reading second financial information through wireless transmission form and transmitting the second financial information to the financial processor, wherein, the financial processor encrypts and transmit the second financial information to the financial transaction center; and a first light transceiver, being arranged on the housing, and connected to the financial processor, capable of emitting a light and receiving the light simultaneously; wherein, the financial processor may know intensity of the light received by the first light transceiver, and the financial processor turns on the wireless data reader as the intensity of the light is larger than a predetermined value.

The present invention also provides operating procedures to operate the financial transaction device having an element for identifying wireless sensing, including the following steps: (S11) a financial processor determines whether or not an intensity of a light received by a first light transceiver is larger than a predetermined value, and subsequently, a step (S12) is executed if yes or a step (S14) is executed if no; (S12) the financial processor turns on a wireless data reader; (S13) the financial processor receives, encrypts and transmits second financial information read by the wireless data reader to a financial transaction center, followed by executing step (S11); (S14) the financial processor determines whether or not first financial information is received from a magnetic stripe reader, and subsequently, step (S15) is executed if yes or step (S11) is executed if no; (S15) the financial processor receives, encrypts and transmits the first financial information read by the magnetic stripe reader to the financial transaction center.

Moreover, achieve the aforementioned objective, the present invention provides a financial transaction device having an element for identifying wireless sensing, and including: a housing; a transaction processor, being contained in the housing, and connected to a financial transaction center through internet; a magnetic stripe reader, being flanked and arranged on the housing, and electrically connected to the financial processor, capable of reading a first financial information from magnetic stripe, and transmitting the first financial information to the financial processor, wherein, the financial processor encrypts and transmits the first financial information to the financial transaction center; a wireless data reader, being arranged on the housing, and electrically connected to the financial processor, also capable of reading a second financial information through wireless transmission form and transmitting the second financial information to the financial processor after being initiated by the financial processor, wherein, the financial processor encrypts and transmit the second financial information to the financial transaction center; and a first light transceiver, being arranged on the housing, and connected to the financial processor, capable of emitting a light and receiving the light simultaneously; wherein, the financial processor can know intensity of the light received by the first light transceiver, and the financial processor starts to receive the second financial information as the intensity of the light is larger than a predetermined value.

The present invention also provides operating procedures to operate the financial transaction device having an element for identifying wireless sensing, including the following steps: (S21) the financial processor determines whether or not an intensity of a light received by a first light transceiver is larger than a predetermined value, followed by executing step (S22) if yes, or executing step (S23) if no; (S22) the financial processor starts to receive, encrypt and transmit second financial information read by a wireless data reader to a financial transaction center, followed by executing step (S21); (S23) the financial processor determines whether or not to receive first financial information from a magnetic stripe reader, followed by executing step (S24) if yes, or executing step (S21) if no; and (S24) the financial transaction processor receives, encrypts and transmits the first financial information read by the magnetic stripe reader to the financial transaction center.

### BRIEF DESCRIPTION OF THE DRAWINGS

FIG. 1 shows a first block diagram of a financial transaction device having an element for identifying wireless sensing according to the invention.

FIG. 2 shows a perspective diagram of a first embodiment of the financial transaction device having the element for identifying wireless sensing.

FIG. 3 shows an operation flow chart in the first embodiment of a financial transaction device having an element for identifying wireless sensing according to the invention.

FIG. 4 shows an operation flow chart in the second embodiment of a financial transaction device having an element for identifying wireless sensing according to the invention.

FIG. 5 shows a second block diagram of the financial transaction device having an element for identifying wireless sensing according to the invention.

FIG. 6 shows a perspective view in a third embodiment of the financial transaction device having an element for identifying wireless sensing according to the invention.

FIG. 7 shows a side view of the third embodiment of the financial transaction device having an element for identifying wireless sensing according to the invention.

FIG. 8 shows a perspective view of a fourth embodiment of the financial transaction device having an element for identifying wireless sensing according to the invention.

FIG. 9 shows a side view of the fourth embodiment of the financial transaction device having an element for identifying wireless sensing according to the invention.

FIG. 10 shows a perspective top view of implementation of the financial transaction device of the invention together with a specially made financial transaction card.

FIG. 11 shows a perspective side view of implementation of the financial transaction device of the invention together with the specially made financial card.

FIG. 12 shows a perspective side view of implementation of the financial transaction device of the invention together with a financial transaction card with an uneven surface.

FIG. 13 shows a block diagram of the financial transaction device having a plurality of wireless data readers according to the invention.

FIG. 14 shows a perspective view of implementation of the financial transaction device having the plurality of wireless data readers according to the invention.

FIG. 15 shows a perspective view of implementation for the first light transceivers of the financial transaction device arranged in a matrix form according to the invention.

### DETAILED DESCRIPTION OF THE PREFERRED EMBODIMENTS

The technical contents and characteristics of the present invention will be apparent with the detailed description of a preferred embodiment accompanied with related drawings as follows. It is noteworthy that the drawings are provided for the purpose of illustrating the present invention, but not intended for limiting the scope of the invention.

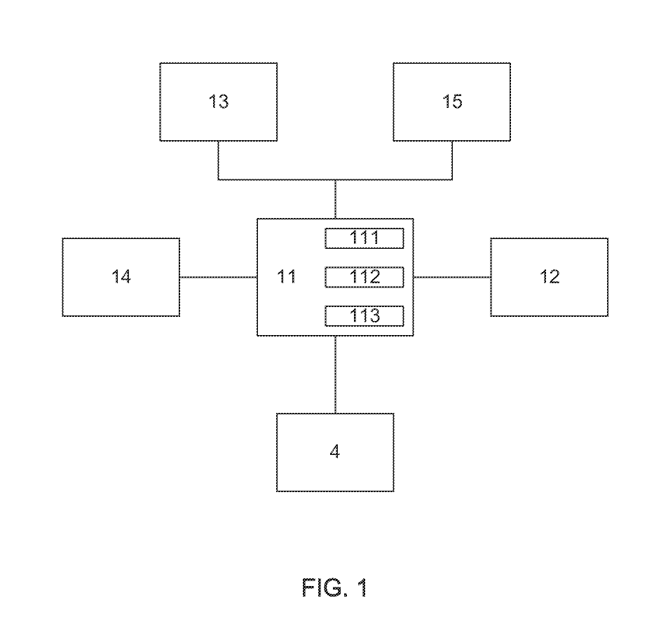

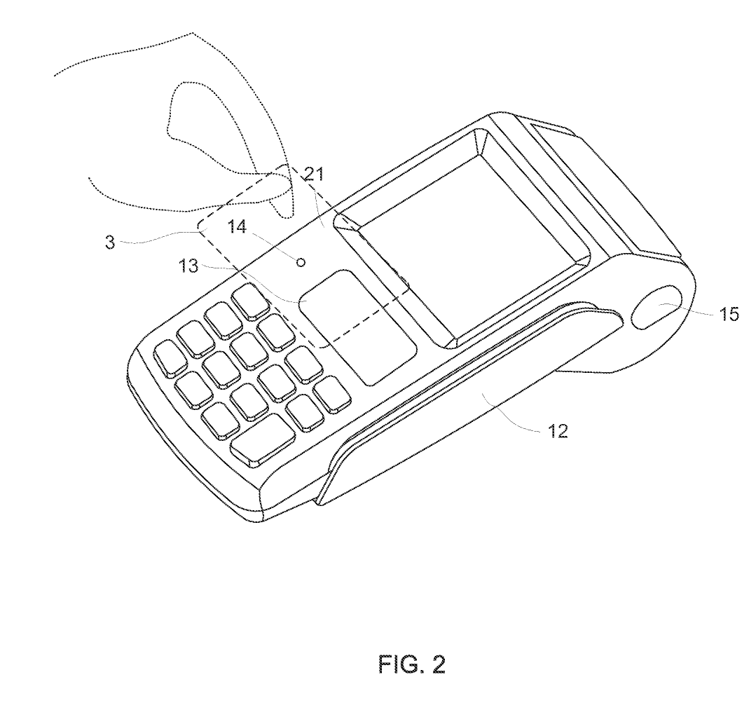

Refer to FIGS. 1 to 2, wherein, FIG. 1 is a first block diagram of a financial transaction device having an element for identifying wireless sensing according to the invention, while FIG. 2 is a perspective diagram of a first embodiment of the financial transaction device having the element for identifying wireless sensing. As shown in FIGS. 1 and 2, the invention is a financial transaction device having an element for identifying wireless sensing, including: a housing 21; a transaction processor 11, being contained in the housing 21, and connected to a financial transaction center 4 through internet; a magnetic stripe reader 12, being arranged on a side of the housing 21, and electrically connected to the financial processor 11, capable of reading a first financial information from a magnetic stripe, and transmitting the first financial information to the financial processor 11, wherein, the financial processor 11 encrypts and transmits the first financial information to the financial transaction center 4; a wireless data reader 13, being arranged on the housing 21, and electrically connected to the financial processor 11, after being initiated by the financial processor 11, capable of reading second financial information through wireless transmission form and transmitting the second financial information to the financial processor 11, wherein, the financial processor 11 encrypts and transmit the second financial information to the financial transaction center 4; and a first light transceiver 14, being arranged on the housing 21, and connected to the financial processor 11, capable of emitting a light and receiving the light simultaneously; wherein, the financial processor 11 may know intensity of the light received by the first light transceiver 14, and the financial processor 11 turns on the wireless data reader 13 as the intensity of the light is larger than a predetermined value. In the invention, the financial transaction center 4 may be a shop, a sale terminal or even a commercial institution such as a bank, and the financial transaction center 4 may determine personal information of a consumer and name and price of a commodity once the first financial information or the second information is received, and return an appropriate message to the financial transaction device of the invention to perform financial transaction behavior.

Subsequently, in the invention, whenever the financial transaction device of the invention is under transaction with the financial transaction center 4, if the light received by the first light transceiver 14 is smaller than the predetermined value, it indicates that position of the financial transaction card 3 under transaction is displaced, not at a correct position above the wireless data reader 13 and not blocking the light emitted by the first light transceiver, as a result, the transaction is regarded as failed, the financial processor 11 turns off the wireless data reader 13 and transmits a transaction interrupt message to the financial transaction center 4 to interrupt the ongoing financial transaction behavior; to achieve such purpose, the financial processor 11 stores a first time 111, a second time 112 and a third time 113; as the light received by the first light transceiver 14 is larger than a predetermined value, after the first time 111 elapses, the financial processor 11 turns on the wireless data reader 13 to perform transaction; if the financial transaction behavior runs exceeding the first time 112, for example, because the financial transaction center 4 does not respond, the transaction is indicated as failed, and the financial processor 11 turns off the wireless data reader 13, and transmits a transaction interrupt message to the financial transaction center 4 to interrupt the transaction; besides, if the intensity of the light received by the first light transceiver 14 is smaller than the predetermined value for more than the third time 113 as the financial transaction behavior is performed within the second time 112, incompleteness of the transaction is indicated, the position of the financial transaction card 3 is displaced and the transaction is regarded as failed, the financial processor 11 turns off the wireless data reader 13 and transmits a transaction interrupt message to the financial transaction center 4 to interrupt the transaction.

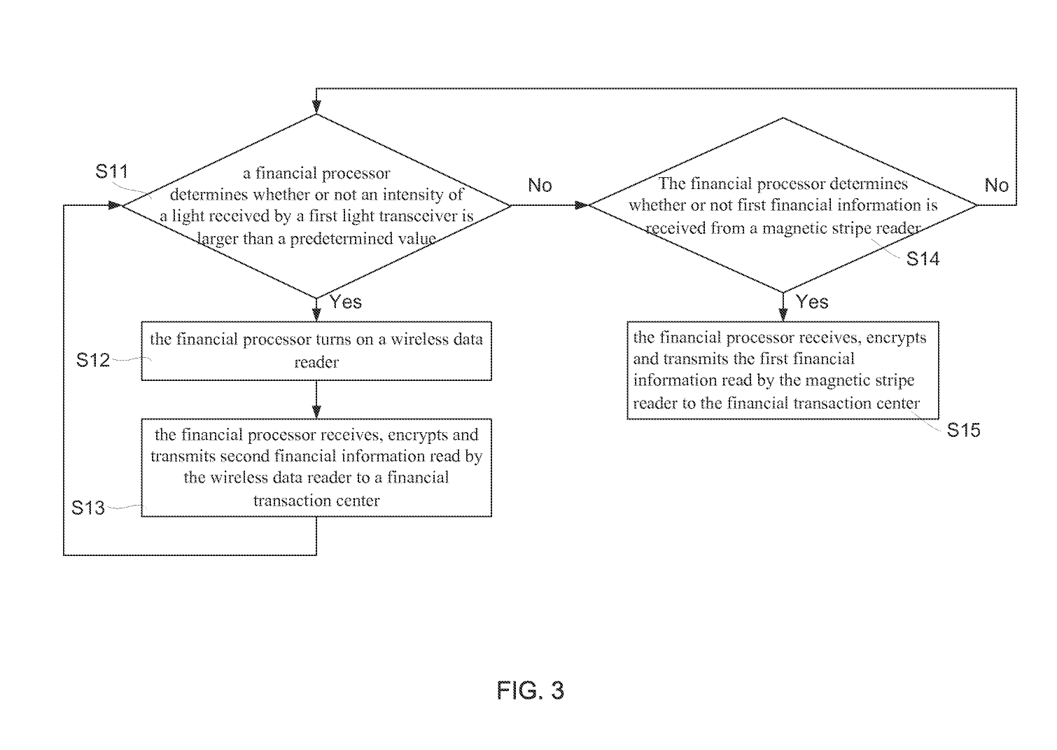

Refer to FIG. 3 now, showing an operation flow chart in the first embodiment of a financial transaction device having an element for identifying wireless sensing according to the invention. As shown in FIG. 3, a financial transaction device having an element for identifying wireless sensing according to the invention may be operated with the following steps: (S11) a financial processor determines whether or not an intensity of a light received by a first light transceiver is larger than a predetermined value, and subsequently, a step (S12) is executed if yes or a step (S14) is executed if no; (S12) the financial processor turns on a wireless data reader; (S13) the financial processor receives, encrypts and transmits second financial information read by the wireless data reader to a financial transaction center, followed by executing step (S11); (S14) the financial processor determines whether or not first financial information is received from a magnetic stripe reader, and subsequently, step (S15) is executed if yes or step (S11) is executed if no; (S15) the financial processor receives, encrypts and transmits the first financial information read by the magnetic stripe reader to the financial transaction center.

In continuation, the financial transaction device of the invention also involve common conventional functions such as password input and so forth, not explained additionally herein. In the invention, as the intensity of the light received by the first light transceiver 14 is smaller than a predetermined value, no financial transaction card 3 being above the wireless data reader 13 is indicated, and the wireless data reader 13 is turned off to avoid duplicate data reading. The wireless data reader 13 is turned off as not used to save power consumption. The first embodiment provides the least elements necessary in the invention, wherein the magnetic stripe reader 12 is most commonly applied, but may be replaced with other machines capable of reading data in the financial transaction card according to the invention.

Keep on referring to FIGS. 1 and 2, the wireless data reader of the invention may further include a confirmation button 15, which is electrically connected to the financial processor 11; wherein, as the confirmation button 15 is pressed, the financial processor 11 ignores whether or not the intensity of the light received by the first light transceiver is larger than the predetermined value, and turns off the wireless data reader 13; in the figures, the confirmation button 15 is arranged on the side of the housing 21, but in fact, the confirmation button 15 may be arranged on the lateral side or the top of the housing 21, or any position convenient for pressing; if the light emitted by the first light transceiver 14 is blocked in an unexpected situation, the light received by the first light transceiver 14 may be larger than the predetermined value, so that the data may suffer from duplicate reading. To avoid such situation, the confirmation button 15 may be pressed to force turning off the wireless data reader 13 to prevent from duplicate data reading.

In continuation, after the confirmation button 15 is triggered, the financial processor 11 turns off the wireless data reader 13, and turns on the wireless data reader 13 again after a fixed time elapses; the fixed time may be adjusted as need, for example, 10 seconds, 9 seconds etc. Besides, the confirmation button 15 may also be designed such that the wireless data reader 13 is turned off only as the confirmation button 15 is triggered.

The invention may further have a second embodiment. Refer to FIG. 1 again, in which the elements in the second embodiment of the invention are the same as those in the first embodiment. The difference is that the wireless data reader 13 continues to be turned on, and continues to read the second financial information, as the intensity of the light received by the first light transceiver 14 is larger than a predetermined value, the financial processor 11 starts to receive, encrypt and transmit the second financial information to the financial transaction center 4. Compared to the first embodiment, in the second embodiment, the wireless data reader 13 continues to work and continues to read the second financial information to increase operation speed.

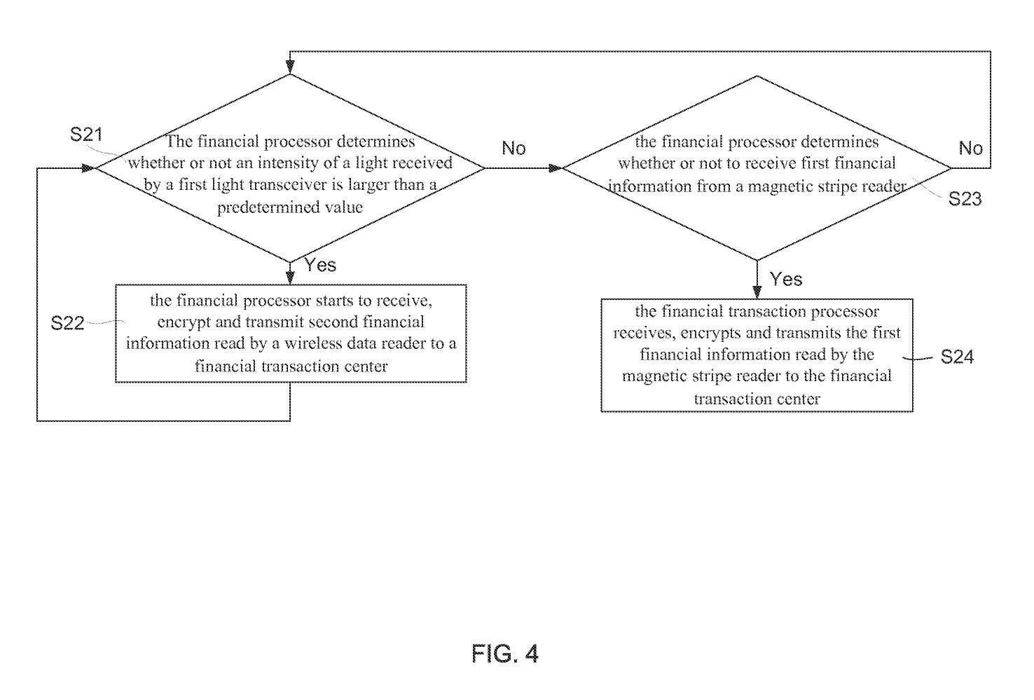

Refer to FIG. 4, showing an operation flow chart in the second embodiment of a financial transaction device having an element for identifying wireless sensing according to the invention. As shown in FIG. 4, the second embodiment of the invention may be operated with the following steps: (S21) the financial processor determines whether or not an intensity of a light received by a first light transceiver is larger than a predetermined value, followed by executing step (S22) if yes, or executing step (S23) if no; (S22) the financial processor starts to receive, encrypt and transmit second financial information read by a wireless data reader to a financial transaction center, followed by executing step (S21); (S23) the financial processor determines whether or not to receive first financial information from a magnetic stripe reader, followed by executing step (S24) if yes, or executing step (S21) if no; subsequently, (S24) the financial transaction processor receives, encrypts and transmits the first financial information read by the magnetic stripe reader to the financial transaction center.

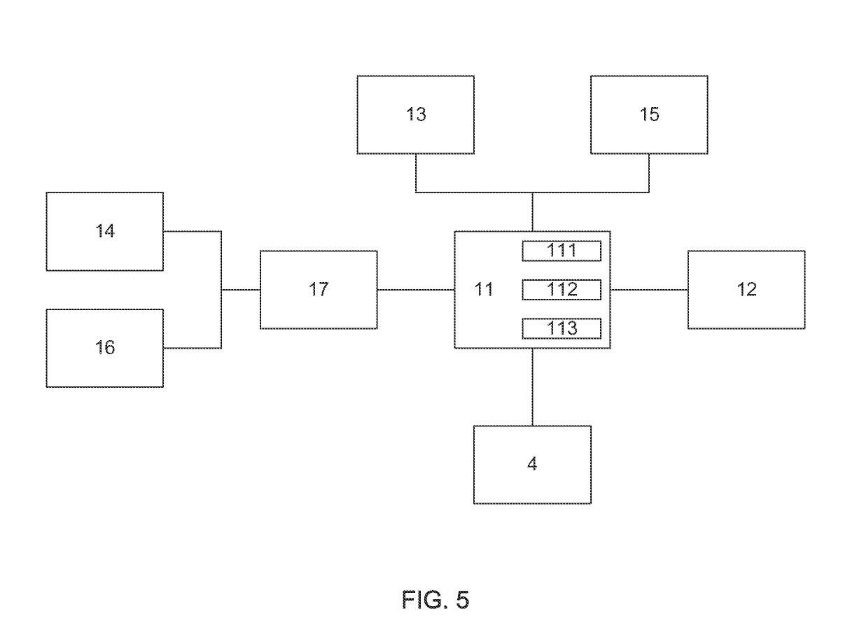

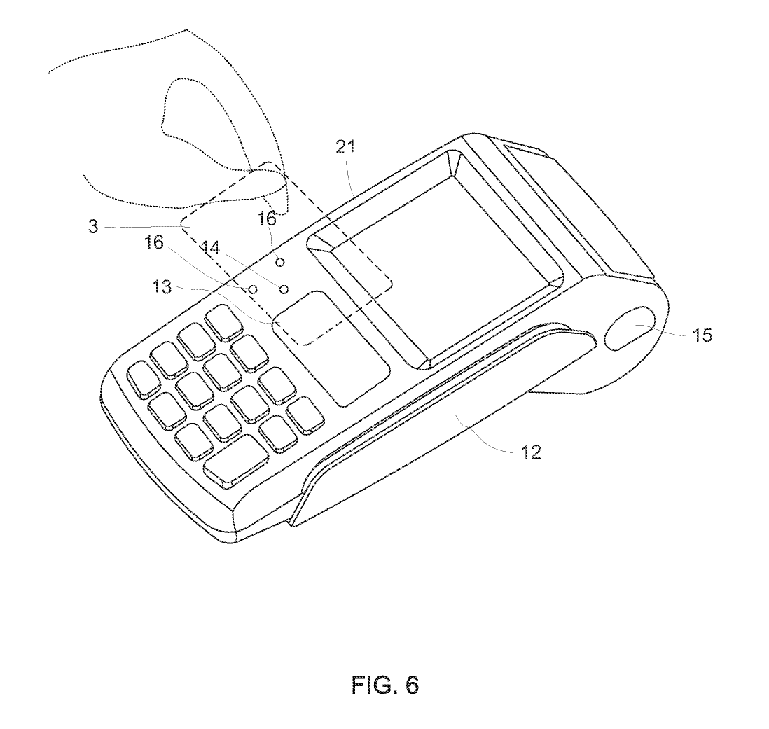

Next, a third embodiment of the invention is introduced. Refer to FIGS. 5 and 6, wherein, FIG. 5 shows a second block diagram of the financial transaction device having an element for identifying wireless sensing according to the invention, while FIG. 6 shows a perspective view in a third embodiment of the financial transaction device having an element for identifying wireless sensing according to the invention. As shown in FIGS. 5 and 6, compared to the first embodiment, the third embodiment of the invention may further include two second light transceivers 16, which is arranged on the housing 21, may emit a light, and receive the light simultaneously; and a light determination unit 17, which is contained in the housing 21, connects with the first light transceiver 14, the second light transceiver 16 and the financial processor 11, and may determine the intensities of the lights received by the first light transceiver 14 and the second light transceiver 16, and transmit a confirmation message or an interrupt message to the financial processor 11. Wherein, the lights emitted by the first light transceiver 141 and the second light transceiver 16 are infrared rays, and the number of the second light transceivers 16 may be changed as need. In reality, the number of the second light transceivers 16 may be only one.

In continuation, as the intensity of the light received by the first light transceiver 14 and the second light transceiver 16 is larger than a predetermined value, after the first time 111 elapses, the light determination unit 17 transmits a confirmation message to the financial processor 11, and the financial processor 11 turns on the wireless data reader 13; after the wireless data reader is turned on, within the second time 112, as the light determination unit 17 determines that the intensity the light received by either the first light transceiver 14 and the second light transceiver 16 is smaller than a predetermined value, and the third time 113 is exceeded, an interrupt message is transmitted to the financial processor 11 by the light determination unit 17, the financial processor 11 turns off the wireless data reader 13, and transmits a transaction interrupt message to the financial transaction center 4.

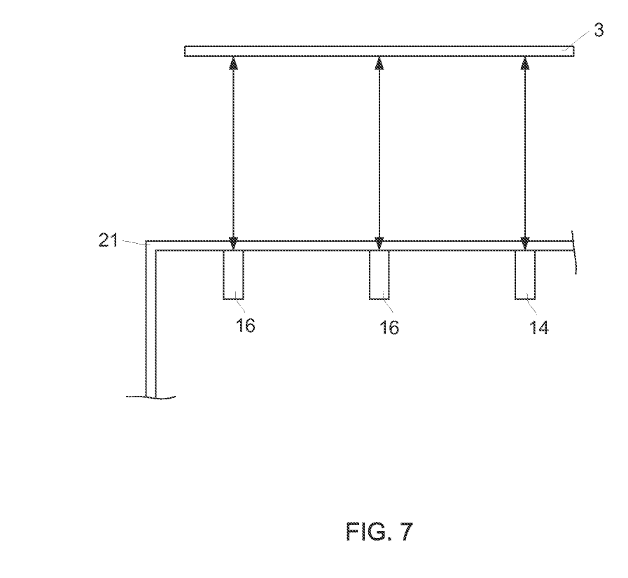

In continuation, refer to FIG. 7, which shows a side view of the third embodiment of the financial transaction device having an element for identifying wireless sensing according to the invention. In the third embodiment, the financial transaction card 3 has to block the lights transmitted by the first light transceiver 14 and the second light transceiver 16 simultaneously, for the intensity of the light received by the first light transceiver 14 and the second light transceiver 16 to be larger than a predetermined value, otherwise the light determination unit 17 does not transmit a confirmation message to the financial processor 11, the financial processor 11 does not turn on the wireless data reader 13, and the transaction cannot be performed. A light determination unit 17 is added in the third embodiment of the invention to share tasks of the financial processor 11. The financial processor 11 turns on or off the wireless data reader 13 according to the confirmation message and the interrupt message transmitted by the light determination unit 17.

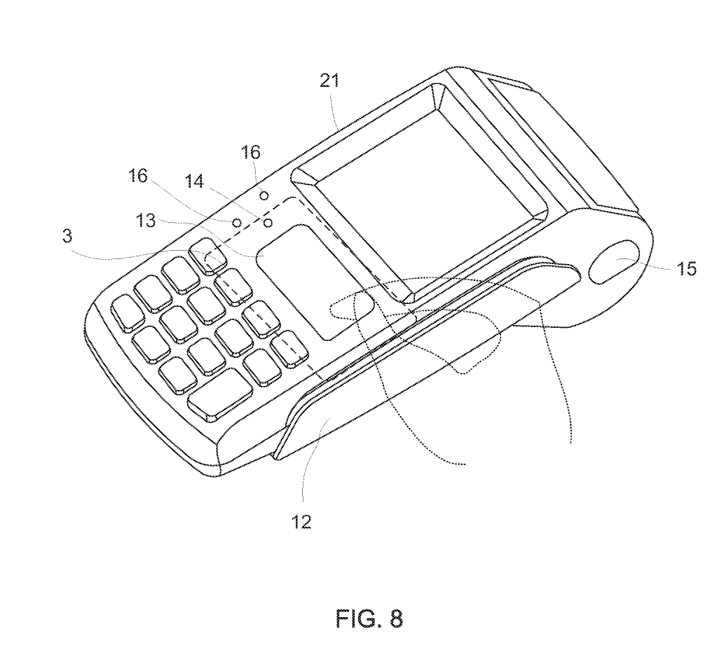

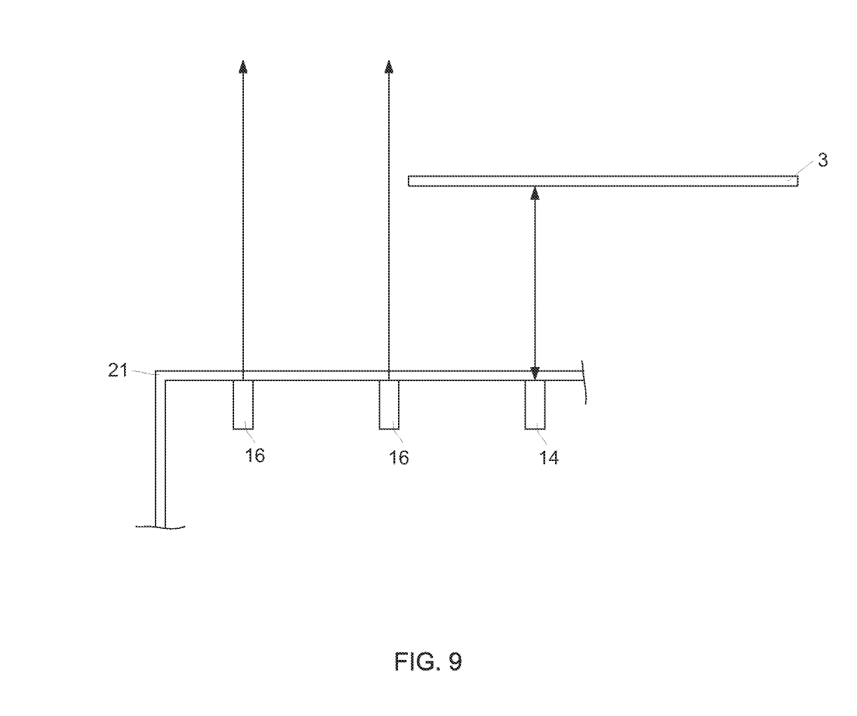

Subsequently, refer to FIGS. 8 and 9, which shows a perspective view of a fourth embodiment of the financial transaction device having an element for identifying wireless sensing according to the invention, and a side view of the fourth embodiment of the financial transaction device having an element for identifying wireless sensing according to the invention, respectively. Elements in the fourth embodiment and those in the third embodiment are the same, the difference lies on operation manner of the light determination unit 17, wherein, as the intensity of the light received by the first light transceiver 14 is larger than a predetermined value, meanwhile, the intensity of the light received by the second light transceiver 16 is smaller than the predetermined value, after the first time 111 elapses, the light determination unit 17 transmits a confirmation message to the financial processor 11, and the financial processor 11 turns on the wireless data reader 13; after the wireless data reader 13 is turned on, within the second time 112, the light determination unit 17 determines situations with respect to whether or not the intensity of the light received by the first light transceiver 14 is smaller than a predetermined value, and the intensity of the light received by the second light transceiver 16 is larger than the predetermined value, once either situation occurs, and the third time 113 is exceeded, an interrupt message is transmitted to the financial processor 11, the financial processor 11 turns off the wireless data reader 13, and transmits a financial interrupt message to the financial transaction center 4. From the figure, in the fourth embodiment, the financial transaction card 3 blocks only the first light transceiver 141 without blocking the second light transceiver 16, such that the intensity of the light received by the first light transceiver 14 is larger than a predetermined value, meanwhile, the intensity of the light received by the second transceiver 16 is smaller than the predetermined value. Compared to the third embodiment, the position of the financial transaction card 3 in the fourth embodiment is more accurate.

From above, the difference between the third and fourth embodiments of the invention lies in the operation manner of the light determination unit 17, wherein, the determination manner with respect to the light received by the first light transceiver 14 and the second light transceiver 16 may be changed by replacing the light determination unit 17 without replacing the financial processor 11. Compared to the first embodiment, more multidimensional developments are available for products in the third embodiment and the fourth embodiment. Besides, for the third embodiment and the fourth embodiment, after the financial processor 11 receives the interrupt message, the receiving of the second financial information read by the wireless data reader may be stopped optionally without the necessity to turn off the wireless data reader.

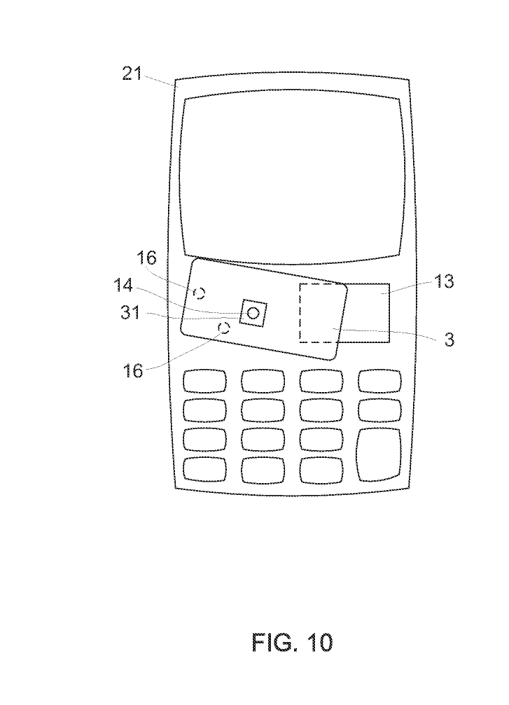

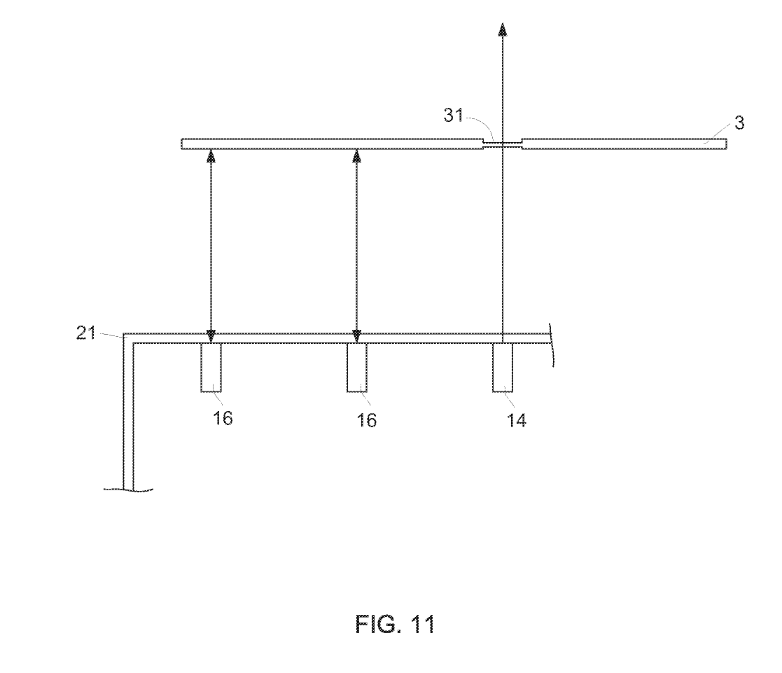

There may be various different aspects and applications in the invention. Refer to FIGS. 10 and 11, which shows a perspective top view of implementation of the financial transaction device of the invention together with a specially made financial transaction card, and a perspective side view of implementation of the financial transaction device of the invention together with the specially made financial card, respectively, in conjunction with the fourth figure. As shown in FIGS. 10 and 11, the specially made financial transaction card 3 has a transparent hole 31, and setting of the light determination unit 17 is reset, as the intensity of the light received by the first light transceiver 14 is smaller than a predetermined value, meanwhile, the intensity of the light received by the two second light transceivers 16 is larger than the predetermined value, that is, in the situation that the first light transceiver 14 is not blocked, the two second light transceivers 16 are not blocked, the light determination unit 17 transmits a confirmation message to the financial processor 11; the specially made financial transaction card 3 has a transparent hole 31, as used, the transparent hole 31 is aligned with the first light transceiver 14, for other portions of the financial transaction card 3 to block the two second light transceivers 16. Of course, settings for the light determination unit 17 may have two types, as the intensity of the light received by the first light transceiver 14 is larger than a predetermined value, meanwhile, the intensity of the light received by the two second light transceivers 16, the light determination unit 17 determine as a general financial transaction card, as the intensity of the light received by the first light transceiver 14 is smaller than a predetermined value, meanwhile, the intensity of the light received by the two second light transceivers 16 is larger than the predetermined value, the light determination unit 17 determines as the specially made financial transaction card. As such, the financial transaction device of the invention may provide different transactions due to different cards, for example, a specially made financial transaction card may be used for services such as discounting or addition of extra points.

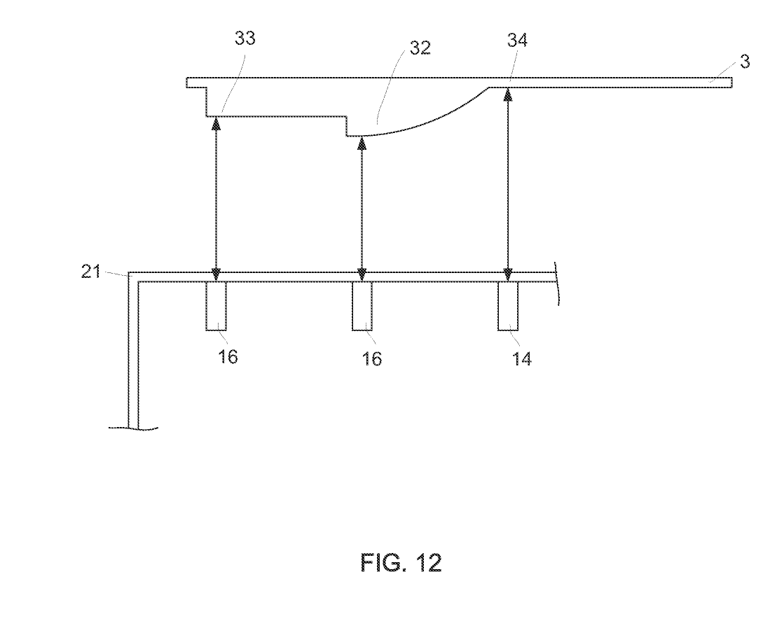

In continuation, besides, the difference between the light received by the first light transceiver 14 and the light received by the second light transceiver 16 may be changed to be within a predetermined range, such that the light determination unit 17 may transmit a confirmation message to the financial processor 11. Refer to FIG. 12, which shows a perspective side view of implementation of the financial transaction device of the invention together with a financial transaction card with an uneven surface. As shown in FIG. 12, the financial transaction card 3 has a first reflection portion 32, a second reflection portion 33 and a third reflection portion 34, as used, the first reflection portion 32 is to align with one of the second light transceivers 16, the second reflection portion 33 is to align with the other one of the second light transceivers 16, the third reflection portion 34 aligns with the first light transceiver 14, subsequently, the light determination unit 17 calculates differences between received lights, and compare whether or not the differences are within the predetermined range, the confirmation message is transmitted to the financial processor 11 only as the difference is within the predetermined range. Thus, in conjunction with above, the light determination unit 17 may have various different settings to determine various different financial transaction cards for transactions to be versatile.

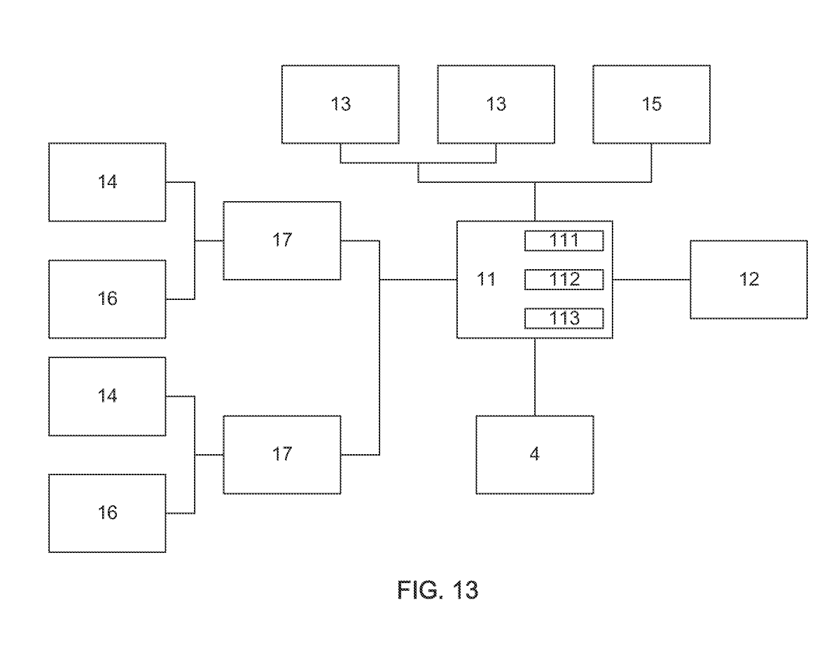

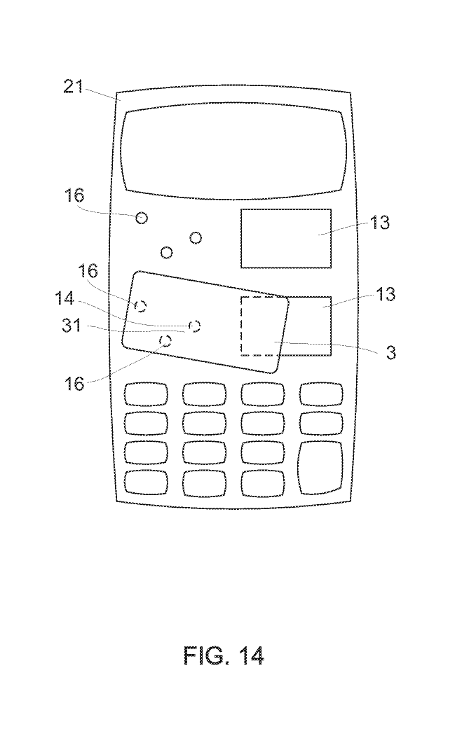

Refer to FIGS. 13 and 14, which show a block diagram of the financial transaction device having a plurality of wireless data readers according to the invention, and a perspective view of implementation of the financial transaction device having the plurality of wireless data readers according to the invention. As shown in FIGS. 13 and 14, the financial transaction device has two wireless data readers 13 and two light determination units 17, each of the wireless data readers 13 corresponding to one of the light determination unit 17, each of the light determination units 17 connects to a first light transceiver 14 and two second light transceivers 16, as a financial transaction card 3 meets the setting of the light determination unit 17 and block the first light transceiver 14 and the second light transceiver 16, the light determination unit 17 that the other wireless data reader 13 corresponds to does not transmit a confirmation message to the financial processor 11. Therefore, the financial transaction device of the invention may prevent two wireless data readers 13 from duplicate data reading.

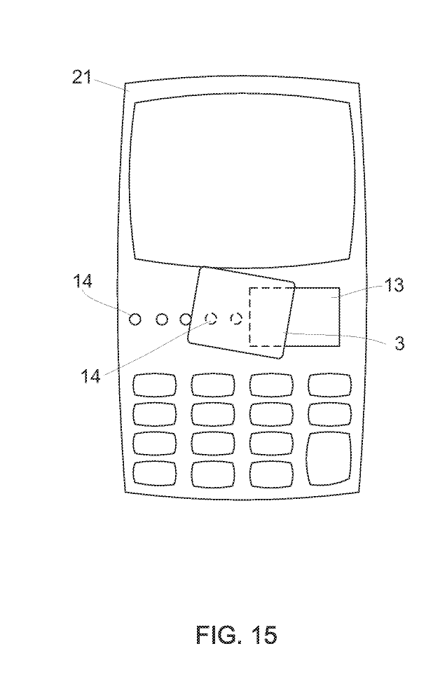

Refer to FIG. 15, which shows a perspective view of implementation for the first light transceivers of the financial transaction device arranged in a matrix form according to the invention. As shown in FIG. 15, the first light transceivers 14 is arranged in a matrix form, as such, the number of the first light transceivers 14 that the financial transaction card 3 with smaller size may block is smaller, relatively, the financial transaction card 3 with larger size may block all first light transceivers 14. The financial transaction device may determine shape or size of the financial transaction card 3, and allow more versatile transactions in terms of the difference.

From above detailed description, the structure of the invention is understood clearly, and it is noted that the financial transaction device having an element for identifying wireless sensing according to the invention has the light emission element, capable of determining whether or not the financial transaction card is at a correct position, as such, when the magnetic stripe reader of the financial transaction device reads data, the wireless data reader does not read data, such that no duplicate data reading occurs.

While the invention has been described by means of specific embodiments, numerous modifications and variations could be made thereto by those skilled in the art without departing from the scope and spirit of the invention set forth in the claims.

What is claimed is:

1. A transactional device having element for identifying wireless sensing, including:
a housing;
a transaction processor, being contained in the housing, and connected to a financial transaction center through internet;
a magnetic stripe reader, being flanked and arranged on the housing, and electrically connected to the financial processor, capable of reading a first financial information from magnetic stripe, and transmitting the first financial information to the financial processor, wherein, the financial processor encrypts and transmits the first financial information to the financial transaction center;
a wireless data reader, being arranged on the housing, and electrically connected to the financial processor, also capable of reading second financial information through wireless transmission form and transmitting the second financial information to the financial processor after being initiated by the financial processor, wherein, the financial processor encrypts and transmit the second financial information to the financial transaction center; and
a first light transceiver, being arranged on the housing, and connected to the financial processor, capable of emitting a light and receiving the light simultaneously; wherein, the financial processor can know intensity of the light received by the first light transceiver, and the financial processor turns on the wireless data reader as the intensity of the light is larger than a predetermined value.

2. The transactional device having element for identifying wireless sensing of claim 1, can be operated with follow steps:
(S11) a financial processor determines whether or not an intensity of a light received by a first light transceiver is larger than a predetermined value, and subsequently, a step (S12) is executed if yes or a step (S14) is executed if no;
(S12) the financial processor turns on a wireless data reader;
(S13) the financial processor receives, encrypts and transmits second financial information read by the wireless data reader to a financial transaction center, followed by executing step (S11);
(S14) the financial processor determines whether or not first financial information is received from a magnetic stripe reader, and subsequently, step (S15) is executed if yes or step (S11) is executed if no;
(S15) the financial processor receives, encrypts and transmits the first financial information read by the magnetic stripe reader to the financial transaction center.

3. The transactional device having element for identifying wireless sensing of claim 1, wherein the financial processor stores a first time, a second time and a third time.

4. The transactional device having element for identifying wireless sensing of claim 3, wherein, as the light received by the first light transceiver is larger than a predetermined value, after the first time elapses, the financial processor turns on the wireless data reader to perform transaction;
the wireless data reader is turned on and exceeding the first time as the intensity of the light received by the first light transceiver is smaller than the predetermined value, the financial processor turns off the wireless data reader, and transmits a transaction interrupt message to the financial transaction center;
the intensity of the light received by the first light transceiver is smaller than the predetermined value for more than the third time within the second time, the financial processor turns off the wireless data reader and transmits a transaction interrupt message to the financial transaction center.

5. The transactional device having element for identifying wireless sensing of claim 3, further including:
a confirmation button, being arranged on the housing, and electrically connected to the financial processor; wherein, as the confirmation button is pressed, the financial processor ignores whether or not the intensity of the light received by the first light transceiver is larger than the predetermined value, and turns off the wireless data reader;
a second light transceivers, being arranged on the housing, and capable of emitting a light as well as receiving the light simultaneously; and
a light determination unit, being contained in the housing, and connected with the first light transceiver, the second light transceiver and the financial processor, capable of determining the intensities of the lights received by the first light transceiver and the second light transceiver, and transmitting a confirmation message or an interrupt message to the financial processor.

6. The transactional device having element for identifying wireless sensing of claim 5, wherein, as the intensity of the light received by the first light transceiver and the second light transceiver is larger than a predetermined value, after the first time elapses, the light determination unit transmits a confirmation message to the financial processor, and the financial processor turns on the wireless data reader;
after the wireless data reader is turned on, within the second time, as the light determination unit determines that the intensity the light received by either the first light transceiver and the second light transceiver is smaller than a predetermined value, and the third time is exceeded, an interrupt message is transmitted to the financial processor by the light determination unit, the financial processor turns off the wireless data reader, and transmits a transaction interrupt message to the financial transaction center.

7. The transactional device having element for identifying wireless sensing of claim 5, wherein, as the intensity of the light received by the first light transceiver is larger than a predetermined value, meanwhile, the intensity of the light received by the second light transceiver is smaller than the predetermined value, after the first time elapses, the light determination unit transmits a confirmation message to the financial processor, and the financial processor turns on the wireless data reader;
after the wireless data reader is turned on, within the second time, the light determination unit determines situations with respect to whether or not the intensity of the light received by the first light transceiver is smaller than a predetermined value, and the intensity of the light received by the second light transceiver is larger than the predetermined value, once either situation occurs, and the third time is exceeded, an interrupt message is transmitted to the financial processor, the financial processor turns off the wireless data reader, and transmits a financial interrupt message to the financial transaction center.

8. The transactional device having element for identifying wireless sensing of claim 5, wherein, the lights emitted by the first light transceiver and the second light transceiver are infrared rays.

9. The transactional device having element for identifying wireless sensing of claim 5, wherein, after the confirmation button is triggered, the financial processor turns off the wireless data reader, and turns on the wireless data reader again after a fixed time elapses.

10. A transactional device having element for identifying wireless sensing, including:
a housing;
a transaction processor, being contained in the housing, and connected to a financial transaction center through internet;
a magnetic stripe reader, being flanked and arranged on the housing, and electrically connected to the financial processor, capable of reading a first financial information from magnetic stripe, and transmitting the first financial information to the financial processor, wherein, the financial processor encrypts and transmits the first financial information to the financial transaction center;
a wireless data reader, being arranged on the housing, and electrically connected to the financial processor, also capable of reading a second financial information through wireless transmission form and transmitting the second financial information to the financial processor after being initiated by the financial processor, wherein, the financial processor encrypts and transmit the second financial information to the financial transaction center; and
a first light transceiver, being arranged on the housing, and connected to the financial processor, capable of emitting a light and receiving the light simultaneously; wherein, the financial processor can know intensity of the light received by the first light transceiver, and the financial processor starts to receive the second financial information as the intensity of the light is larger than a predetermined value.

11. The transactional device having element for identifying wireless sensing of claim 10, can be operated with follow steps:
(S21) the financial processor determines whether or not an intensity of a light received by a first light transceiver is larger than a predetermined value, followed by executing step (S22) if yes, or executing step (S23) if no;
(S22) the financial processor starts to receive, encrypt and transmit second financial information read by a wireless data reader to a financial transaction center, followed by executing step (S21);
(S23) the financial processor determines whether or not to receive first financial information from a magnetic stripe reader, followed by executing step (S24) if yes, or executing step (S21) if no; and
(S24) the financial transaction processor receives, encrypts and transmits the first financial information read by the magnetic stripe reader to the financial transaction center.

12. The transactional device having element for identifying wireless sensing of claim 10, wherein the financial processor stores a first time, a second time and a third time.

13. The transactional device having element for identifying wireless sensing of claim 12, wherein, as the light received by the first light transceiver is larger than a predetermined value after the first time elapses, the financial processor starts to receive the second financial information;
when exceeding the first time as the intensity of the light received by the first light transceiver is larger than the predetermined value, the financial processor stops to receive the second financial information, and transmits a transaction interrupt message to the financial transaction center;
the intensity of the light received by the first light transceiver is smaller than the predetermined value for more than the third time within the second time, the financial processor stops to receive the second financial information and transmits a transaction interrupt message to the financial transaction center.

14. The transactional device having element for identifying wireless sensing of claim 12, further including:
a confirmation button, being arranged on the housing, and electrically connected to the financial processor; wherein, as the confirmation button is pressed, the financial processor ignores whether or not the intensity of the light received by the first light transceiver is larger than the predetermined value, and starts to receive the second financial information;
a second light transceivers, being arranged on the housing, and capable of emitting a light as well as receiving the light simultaneously; and
a light determination unit, being contained in the housing, and connected with the first light transceiver, the second light transceiver and the financial processor, capable of determining the intensities of the lights received by the first light transceiver and the second light transceiver, and transmitting a confirmation message or an interrupt message to the financial processor.

15. The transactional device having element for identifying wireless sensing of claim 14, wherein, as the intensity of the light received by the first light transceiver and the second light transceiver is larger than a predetermined value, after the first time elapses, the light determination unit transmits a confirmation message to the financial processor, and the financial processor starts to receive the second financial information read by the wireless data reader;
the wireless data reader is turned on, within the second time, as the light determination unit determines that the intensity the light received by either the first light transceiver and the second light transceiver is smaller than a predetermined value, and the third time is exceeded, an interrupt message is transmitted to the financial processor by the light determination unit, the financial processor stops to receive the second financial information read by the wireless data reader, and transmits a transaction interrupt message to the financial transaction center.

16. The transactional device having element for identifying wireless sensing of claim 14, wherein, as the intensity of the light received by the first light transceiver is larger than a predetermined value, meanwhile, the intensity of the light received by the second light transceiver is smaller than the predetermined value, after the first time elapses, the light determination unit transmits a confirmation message to the financial processor, and the financial processor starts to receive the second financial information read by the wireless data reader;
the wireless data reader is turned on, within the second time, the light determination unit determines situations with respect to whether or not the intensity of the light received by the first light transceiver is smaller than a predetermined value, and the intensity of the light received by the second light transceiver is larger than the predetermined value, once either situation occurs, and the third time is exceeded, an interrupt message is transmitted to the financial processor, the financial processor stops to receive the second financial information read by the wireless data reader, and transmits a financial interrupt message to the financial transaction center.

17. The transactional device having element for identifying wireless sensing of claim 10, wherein, the lights emitted by the first light transceiver and the second light transceiver are infrared rays.
